(19) United States
(12) Patent Application Publication
(10) Pub. No.: US 2006/0225672 A1
(43) Pub. Date: Oct. 12, 2006

(54) Vapor injection system for an internal combustion engine

(76) Inventors: Harvey Donahue, Princeton (CA); Brenda Hoy, New Westminster (CA)

Correspondence Address: JENSEN + PUNTIGAM, P.S., SUITE 1020, 2033 6TH AVE, SEATTLE, WA, 98121, US

(21) Appl. No.: 11/102,529

(22) Filed: Apr. 8, 2005

(51) Int. Cl. F02B 47/02

(52) U.S. Cl. 123/25 P

(57) ABSTRACT

The vapor injection system includes a source of water for an ultrasonic generator system which converts water into a gaseous colloid, which is then directed into a misting chamber. The vapor from the misting chamber is directed into an air stream from the air filter portion of the engine. The air/vapor mixture is directed to a turbocharger, which is connected to the intake manifold of the engine. The air/vapor mixture is carried into the combustion chambers of the engine in turn during the intake portion of the engine cycle, the mixture being compressed and heated in the combustion chambers to a high temperature which results in steam. Fuel is then injected into the combustion chamber either during the compression cycle or the intake cycle, depending on which type of engine is used, and the resulting mixture is then ignited.

### TECHNICAL FIELD

This invention relates generally to internal combustion engines, and more specifically concerns a system for injecting water vapor into the combustion chambers of the engine as part of the combustion process.

### BACKGROUND OF THE INVENTION

Historically, there have been many attempts to improve the performance of internal combustion engines, including attempting to increase gas mileage by injecting water into the engine's combustion chambers. Most of these attempts, however, have proved to be unsuccessful and/or any improved results have not been sustainable over an extended period of operation. Further, in some cases, engines have actually been damaged during extended operations with water injection systems.

In addition, those water injection systems which have been successful in improving the efficiency of engines, with improved gas mileage, are usually complex and expensive, particularly in the regulation of the amount of water directed into the engine, relative to the speed of the engine.

Hence, a simple, inexpensive, self-regulating system for using water vapor in internal combustion engines, to improve performance, is desirable.

### SUMMARY OF THE INVENTION

Accordingly, the present invention is a vapor injection system for an internal combustion engine, comprising: a source of water; a generator system for converting water into a vapor; a connecting line for directing the vapor into a stream of air from an air filter portion of the engine, wherein the resulting mixture of air and vapor is directed to a turbocharger for the engine; an air/vapor injector system for moving the resulting air/vapor mixture from the turbocharger into the combustion chambers of the engine in turn during a compression portion of the engine cycle, the air/vapor mixture being converted to steam in the combustion chambers; and a fuel injector system for delivering fuel into the combustion chambers in turn after the previously injected air/vapor mixture has been converted to steam in the combustion chambers, wherein the resulting combination of the steam and fuel is then ignited during the combustion phase of the engine cycle.

### BRIEF DESCRIPTION OF THE DRAWING

FIG. 1 is a block diagram of the water vapor system of the present invention.

### BEST MODE FOR CARRYING OUT THE INVENTION

In the embodiment of the present invention shown and described herein, water is first converted into a vapor/cold mist and then is combined with the flow of air from the air filter of the vehicle to the intake of the engine. The combination of air and vapor is then directed into the individual combustion chambers of an engine during the compression portion of the cycle. The air/water vapor mixture is compressed and heated in the combustion chambers. Fuel is injected into each combustion chamber when the piston reaches top dead center and the mixture is then ignited.

This system increases the efficiency of the engine, typically resulting in an improvement in mileage within the range of 10%-20%, for both gas and diesel internal combustion engines, as well as substantially reducing or even eliminating nitrous oxide emissions from the exhaust of the engine. No carbon dioxide is produced during the process.

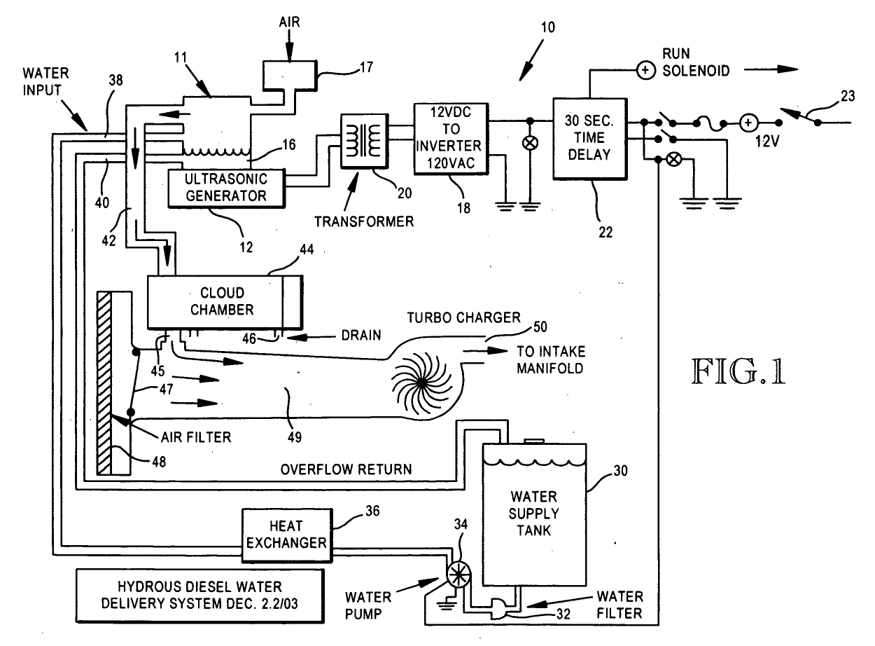

More particularly, referring now to FIG. 1, the system 10 includes an agitation chamber 11 for the water and an ultrasonic generator 12 which is positioned in the agitation chamber 11, which in operation produce a gaseous colloid (water vapor in a cloud-like form). In the embodiment shown, the ultrasonic generator operates with a 1.8 MHz oscillator. The agitation chamber 11 is shown partially filled with water 16. Air is provided to the agitation chamber through an air filter 17.

The ultrasonic generator 12 is powered by a 12 volt DC to 120 volt AC inverter 18 and a transformer 20 which produces an output voltage appropriate for the generator. A timer 22 provides in the embodiment shown a short time delay after the engine is initially turned on by key switch 23 before the ultrasonic generator begins operation.

Water is supplied to the agitation chamber 11 from a water supply tank 30. Water from tank 30 is directed through a water filter 32 and then moved by a pump 34 to a heat exchanger 36. Water from the heat exchanger is pumped through input 38 into agitation chamber 11. The level of water 16 in the agitation chamber is prevented from increasing beyond a selected height by an overflow/return line 40 which extends back to the water supply tank 30. In the embodiment shown, water supply tank 30 is mounted physically below the position of the agitation chamber/ultrasonic generator combination. This provides a proper overflow to maintain the water level at the desired depth within agitation chamber 11.

The gaseous colloid produced within agitation chamber 11 by action of ultrasonic generator 12 is directed through connecting line 42 to a standby chamber 44, also referred to as a “cloud chamber”. The gaseous colloid which is directed to the cloud chamber has a small enough droplet size that it “floats” in the atmosphere of the chamber, resulting in a vapor/cold mist. If the mist condenses within the cloud chamber, the resulting liquid exits through a drain opening 46. The vapor/cold mist in cloud chamber 44 moves out of chamber 44 through an exit line 45 to an air intake line 46, which is the line from the engine air filter 48 to the intake manifold of the engine. The vapor/mist mixes with the moving air in intake line 46, resulting in a moving air/vapor mixture. This mixture is directed to a turbocharger 50 for the engine. The turbocharger 50 is connected to the intake manifold (not shown) of the engine.

A valve 47 is positioned at the entry to air intake line 46. This valve ensures that there is enough air in the agitation chamber for proper operation of the system. Valve 47 is held closed normally by a spring (not shown), which opens the valve when a high flow of air is demanded by the engine and closes the valve when the demand for air decreases. Proper spring pressure is important to maintain a lower air pressure in the lines and in the vapor generator (cloud chamber) 44. This can also be accomplished through the use of sensors and associated electronic control of the valve operation.

The pressure in the cloud chamber 44 and inlet line 46 must be low enough that the vapor will not change back into water. Further, the size of line 46 must be the correct size to accommodate the required amount of vapor. If the vapor becomes too dense, it will change back to water. Hence, the size of the intake line 46, the amount of the vapor in line 46 and chamber 44, and the air pressure in the line, relative to the outside air pressure, are interrelated. They are selected to prevent the vapor from changing back to water.

In operation of the embodiment shown, the air/vapor mixture in the intake line 46 is injected into each combustion chamber in the engine in turn during the compression stroke of that chamber. The mixture in the chamber is compressed and heated. Typically, the temperature of the mixture in the chamber will reach 700° F., with the air/vapor mixture being converted to steam. When the piston in the chamber reaches top dead center position in the operating cycle, fuel is injected into the chamber. The resulting mixture of steam and fuel is then ignited, completing the combustion process.

The system of the present embodiment is self-regulating in operation, i.e. as the stream of air in intake line 46 from air filter 48 increases or decreases, due to a change in the demand of the engine, the vacuum in the line also correspondingly increases or decreases. As the vacuum increases, so does the amount of vapor directed into the engine. Correspondingly, as the vacuum decreases, the amount of vapor decreases. This self-regulation occurs because of the location and manner in which the water vapor/mist is combined with air from the air filter in inlet line 46, between the air filter 48 and turbocharger 50, as well as the operation of valve 47.

As indicated above, the present system results in an improvement in gas mileage of the internal combustion engine (gas or diesel) in the range of 10%-20%, which is a significant improvement. The temperature in the combustion chambers is reduced, as well as that of the exhaust gases. This results in the fuel withstanding pre-combustion without decomposing into products that will ignite before the actual ignition part of the cycle, referred to as pre-ignition, which results in knocking. The computer system maintaining exhaust temperature will thus move to an optimum setting, resulting in improved fuel economy. The elimination of pre-ignition opens up the possibility of using higher compression engines with lead-free fuel. Furthermore, emissions from the diesel engine are decreased, notably the amount of nitrous oxide. No carbon dioxide is produced. Still further, in a gas engine, “pre-ignition” is significantly reduced or eliminated.

Hence, a new system for injecting water vapor into an internal combustion engine, which is also self-regulating, has been disclosed.

Although a preferred embodiment of the invention has been disclosed here for purposes of illustration, it should be understood that various changes, modifications and substitutions may be incorporated in the embodiment without departing from the spirit of the invention, which is defined by the claims which follow.

What is claimed is:

1. A vapor injection system for an internal combustion engine system, comprising:
a source of water;
a generator system for converting water into a vapor;
a connecting line for directing the vapor into a stream of air from an air filter portion of the engine system, wherein the resulting mixture of air and vapor is directed to a turbocharger for the engine;
an air/vapor injector system for moving the resulting air/vapor mixture from the turbocharger into the combustion chambers of the engine in turn during a compression portion of the engine cycle, the air/vapor mixture being converted to steam in the combustion chambers; and
a fuel injector system for delivering fuel into the combustion chambers in turn after the previously injected air/vapor mixture has been converted to steam in the combustion chambers, wherein the resulting combination of the steam and fuel is then ignited during the combustion phase of the engine cycle.

2. The system of claim 1, wherein the temperature of the steam in the combustion chamber is approximately 700° F.

3. The system of claim 1, wherein the vapor generator system includes a water chamber and an ultrasonic generator associated therewith.

4. The system of claim 3, wherein the frequency of operation of the ultrasonic generator is approximately 1.8 MHz.

5. The system of claim 1, wherein the vapor is injected into the stream of air between the air filter and the turbocharger and wherein the stream of air carries the vapor along.

6. The system of claim 1, including a valve assembly in the air/vapor injection system for controlling the amount of air in the air/vapor injection system.

7. The system of claim 1, including a misting chamber for automatically receiving a gaseous medium from the generator system and an outlet from the misting chamber to the connecting line.

8. The system of claim 4, wherein the source of water is located physically below the generator system.

9. The system of claim 6, wherein the amount of vapor directed into the stream of air changes with the amount of air demanded by the engine in operation and therefore is self-regulating.

10. The system of claim 1, including a timer for delaying, for a short, selected period of time, start-up of operation of the generator system following starting of the engine.

11. The system of claim 3, including an overflow outlet from the generator system to ensure that the level of water in the water chamber does not rise above a selected level.

12. The system of claim 1, wherein the internal combustion engine is a gas engine or a diesel engine.

13. A vapor injection system for an internal combustion engine system, comprising:
a system for converting water into a vapor;
a connecting member for directing the vapor into an inlet stream of air for the engine, forming an air/vapor mixture;
an assembly for receiving the air/vapor mixture, performing selected operations on the air/vapor mixture, if any, and moving the resulting mixture into the combustion chambers of the engine in turn during a compression portion of the operating cycle of each cylinder, the mixture being converted to steam in the combustion chambers; and
a fuel system for delivering fuel into the combustion chambers in turn following the conversion of the mixture in the combustion chambers to steam, wherein the resulting combination of steam and fuel is then ignited during the combustion phase of the engine cycle.
